(19) United States
(12) Patent Application Publication
(10) Pub. No.: US 2006/0246596 A1
(43) Pub. Date: Nov. 2, 2006

(54) Reagent delivery device and method

(75) Inventor: Ivars Jaunakais, Rock Hill, SC (US)

Correspondence Address: TIMOTHY R. KROBOTH;KROBOTH LAW OFFICE, 5501 PROVIDENCE COUNTRY CLUB DRIVE, CHARLOTTE, NC, 28277, US

(73) Assignee: Industrial Test Systems, Inc.

(21) Appl. No.: 11/117,536

(22) Filed: Apr. 29, 2005

(51) Int. Cl. G01N 31/22

(52) U.S. Cl. 436/109

(57) ABSTRACT

Semi-quantitative colorimetric analysis of a fibrous matrix disposed on a support, and quantitative analysis of liquid color, are described. Cyanide and a halogenating reagent are reacted to produce a cyanogen halide, and Konig reagents are reacted with the cyanogen halide to yield a colorimetrically analyzable complex. A beneficial photometric method is also described. In addition, a reagent delivery device that includes a beneficial fibrous matrix for rapid delivery of reagents and rapid liquid color analysis, is described.

### FIELD OF THE INVENTION

This invention relates to colorimetric analysis based upon the Konig Reaction, in particular of cyanide.

### BACKGROUND OF THE INVENTION

Cyanide can be present in various forms in water. A particular concern is free cyanide ion. In drinking water, at high doses, this form of cyanide inhibits cellular respiration and can result in death. Because of the toxicity to humans, the U.S. EPA has set 0.2 mg/L as the maximum concentration that can be present in drinking water. Sodium cyanide, potassium cyanide and certain other cyanide salts, release cyanide ion when dissolved in water.

Cyanide complexes, on the other hand, are weakly, moderately or strongly complexed cyanide complexes, require liberation of free cyanide, and consequently are considered less toxic than simple soluble cyanides such as potassium cyanide and sodium cyanide. As described by Volmer et al, “Simplifying Cyanide Analysis with Microdistillation”, American Laboratory News, pp. 18, 20, 22 (January 2000), cyanide complexes may be treated to liberate cyanide ion by using a citrate/phosphoric acid mixture at boiling temperature, and hydrocyanic acid distillation into sodium hydroxide solution. Also known as illustrated by Bradbury et al, Acta Hort. vol. 375, pp. 87-96 (1994), is the liberation of free cyanide from plant material.

The usefulness of cyanide analysis is not limited to drinking water, but rather has wide applicability including to plant material, food, blood chemistry, and to many different industrial processes including to industrial wastewater. However, as described by Barnes et al, “Techniques for the Determination of Cyanide in a Process Environment: A Review”, Geostandards Newsletter, vol. 24, no. 2, pp. 183-195 (December 2000), accurate determination of cyanide is difficult for various reasons. Free cyanide is a good complexing agent, is easily oxidized, breaks down in sunlight, and is sensitive to pH. When considering sample storage, dechlorination, increasing the sample alkalinity to exceed pH 11 or 12, and shielding the sample from UV radiation and oxygen benefit the stability of cyanide.

Certain prior art methods for colorimetric analysis are based upon the Konig Reaction. In these analyses, a cyanogen halide reacts with a cyanogen halide-reactive pyridine compound to produce a Konig Reaction intermediate that reacts with a barbituric acid compound to yield a colorimetrically analyzable, colored complex. Chloramine-T, N-chlorosuccinimide/succinimide, and sodium hypochlorite exemplify prior art chlorinating reagents for converting cyanide to cyanogen chloride for cyanide analysis. Similarly, for chlorine analysis, for example, chlorine can be reacted with a water soluble alkali metal cyanide to produce a cyanogen chloride to be reacted with Konig reagents.

Pyridine, pyridinium salts such as pyridinium trifluoroacetate, and pyridine derivatives such as γ-picoline (4-methylpyridine), nicotinic acid and isonicotinic acid (4-pyridinecarboxlic acid), nicotinamide, and pyridine-3-nitrophthalic acid, are exemplary of pyridine compounds described as useful in the Konig Reaction. Barbituric acid, barbituric acid derivatives such as 1,3-dimethylbarbituric acid (“1,3-DMB”), and thiobarbituric acid derivatives such as 1,3-diethyl-2-thiobarbituric acid exemplify color-forming barbituric acid compounds described as useful in the Konig Reaction.

As described by Bradbury, color development of a liquid sample is affected not only by the reaction environment pH but also may be affected by the selection of buffer. For isonicotinic acid (“INA”)/barbituric acid color-forming chemistry (sodium hydroxide added), optimized absorbance is found using a 0.2M phosphate or acetate buffer when the final pH is in the range of from about 5.2 to 6.5. On the other hand, Bradbury describes optimized absorbance to be fairly constant using 0.2 M acetate buffer and pyridine/barbituric acid color-forming chemistry, when the final pH is in the range of about 4.2 to 6.6, but a narrow pH range for optimized absorbance using 0.2 M phosphate buffer.

Depending upon the particular color-forming chemistry, the colorimetrically analyzable, colored complex produced by the Konig Reaction, varies in color, and accordingly an appropriate wavelength for photometric analysis varies. It is known in the prior art to evaluate the sample color, or the color of a test strip pad. The color may be evaluated visually or photometrically.

In the photometric analysis art, after a BLANK reading using a sample contained in a photometer cell, the photometer cell is often removed from a photometer for the addition of the analytical agents to the cell and sample, and thereafter is re-inserted in the photometer to obtain analytical results. To minimize variability of measurements, it is recognized that the photometer cell should be re-inserted so that the cell has the same orientation. Otherwise, variability in the geometry and quality of the cell glass can cause variability of measurements. Furthermore, the exterior of a photometric cell should be free of smudges or fingerprints or a water drop to ensure an accurate reading.

Prior art colorimetric methodologies for cyanide analysis based upon the Konig Reaction, typically rely upon analysis of sample color, and are exemplified by the methodologies of Volmer et al (chloramine-T with phthalate buffer; 5 minute waiting time; 1:9.3 ratio, on a weight basis, of isonicotinic acid (“INA”) to 1,3-DMB dissolved in sodium hydroxide solution; 40 minute color development time), Macherey-Nagel GmbH & Co (chloramine-T; 1,3-DMB and INA reagent solution; 15 minute color development time), Hach Chemical Co. (phosphate buffer in powder or pellet form; 1,3-DMB and 1,3-DMB sodium, in pellet form, or 3-methyl-1-phenyl-2-pyrazolin-5-one in powder form; pyridine hydrochloride solution, or pyridine-3-nitrophthalic acid in powder form), Lamotte (3.3:1 ratio, on a weight basis, of pyridinium trifluoroacetate to barbituric acid, 20 minute color development time), U.S. Pat. No. 4,227,888 to Rueppel et al (phosphate-buffered, chloramine-T solution; barbituric acid and pyridine reagent solution), Chemetrics, Inc. (0.5% sodium hypochlorite solution, and sodium phosphate monobasic buffer solution; 2:1 ratio, on a weight basis, of INA to barbituric acid dissolved in sodium hydroxide solution in an evacuated glass ampoule with a frangible tip; 15 minute color development time), Nagashima, Analytica Chimica Acta., vol. 91, pp. 303-306 (1977) (chloramine-T and phosphate buffer solutions; 1-2 minute waiting time; 15 ml of γ-picoline and 3 g of barbituric acid; 5 minute color development time at 25° C.), Nagashima, Analytica Chimica Acta, vol. 99, pp. 197-201 (1978) (chloramine-T and phosphate buffer solutions; 1-2 minute waiting time; 1:1 ratio, on a weight basis, of sodium isonicotinate to sodium barbiturate), and Essers et al, Journal of the Science of Food and Agriculture, vol. 63, pp. 287-296 (1993) (chloramine-T and phosphate buffer solutions; 1,3-DMB and INA dissolved in sodium hydroxide solution). Test strip analysis is exemplified by the EMD Chemicals Inc. cyanide test (pyridine, barbituric acid derivative; immerse test pad for 30 seconds, evaluate test pad color within 10 seconds). However, each methodology has one or more drawbacks relating to sample pH range, cyanide ion range, significant waiting time between the halogenation reaction and Konig Reaction, speed of color development, sensitivity, accuracy, reproducibility, use of glass ampoules with frangible tips, and dissolution of solids.

As illustrated by U.S. Pat. No. 3,937,613 to Rosicky and U.S. Pat. No. 4,275,031 to Fischer et al, prior art reagent delivery devices that include a support such as an inert plastic strip or the like, and that release analytical agents for evaluation of sample color are known. However, none of these reagent delivery devices involves chemistry related to colorimetric cyanide analysis.

Despite the foregoing advances, there continues to be a need for cyanide analysis of a liquid sample that will provide improved sample pH range, improved cyanide ion range, improved speed of color development, and improved sensitivity, accuracy and reproducibility. In addition, there continues to be a need for an improved photometric analysis method.

### SUMMARY OF THE INVENTION

In accordance with the present invention, an effective amount of a suitable water soluble halogenating reagent for reacting with the cyanide in an aqueous sample to yield a cyanogen halide, is reacted with the cyanide in an appropriately buffered reaction environment. A chlorinating or brominating agent may be used as the halogenating agent, and may be added to the aqueous sample with an effective amount of a suitable water soluble buffer. In accordance with a preferred feature of the invention, the halogenating reagent and buffer may be delivered into the sample from a reagent delivery device in accordance with the invention.

In further accordance with the present invention, an effective amount of a suitable water soluble cyanogen halide-reactive pyridine compound for providing a Konig Reaction intermediate, and an effective amount of a suitable water soluble barbituric acid compound for reacting with the Konig Reaction intermediate to yield a colorimetrically analyzable, colored complex, are delivered into the resulting cyanogen halide-containing liquid. Advantageously, this step may begin within about one minute after the conversion of cyanide to cyanogen halide begins.

Beneficially, in accordance with the invention, the Konig Reaction is carried out in an appropriately buffered reaction environment, and the pyridine compound and the barbituric acid compound may be delivered by wetting-contact of a fibrous matrix fixed to a support of a reagent delivery device in accordance with the invention, with the cyanogen halide-containing liquid. Advantageously, a mixing action is provided by movement of the fibrous matrix and support in the liquid.

Within an appropriate period of time after beginning the wetting-contact, the fibrous matrix is withdrawn from the liquid. A preferred contact time is generally less than one minute. Thereafter, in accordance with a beneficial aspect of the invention, the fibrous matrix color may be analyzed to obtain a semi-quantitative determination of the level of cyanide in the aqueous sample. In a highly advantageous embodiment, the fibrous matrix may be withdrawn within about thirty seconds after beginning the wetting-contact, and color analysis may immediately follow. As a result, semi-quantitative analysis may be achieved within about two minutes or less from beginning the conversion of cyanide to cyanogen halide.

Furthermore, in accordance with a beneficial aspect of the invention, within about ten minutes, desirably within about two to three minutes or less, after withdrawing the fibrous matrix from the liquid, the color of the liquid may be photometrically analyzed for quantitative determination of the level of cyanide in the aqueous sample.

In accordance with a beneficial inventive photometric analysis method, a photometric cell containing the aqueous sample is disposed in a photometric instrument, and the halogenating reagent is delivered into the aqueous sample from a reagent delivery device in accordance with the invention. Advantageously, in accordance with the beneficial inventive photometric analysis method, the color-forming Konig reagents are delivered into the aqueous sample from a fibrous matrix fixed to a reagent delivery device in accordance with the present invention, and photometric cell remains in the photometric instrument until after photometric analysis of the liquid. If desired, the fibrous matrix color may be analyzed to obtain a semi-quantitative determination of the level of cyanide in the aqueous sample. In its broadest aspect, the beneficial photometric analysis method is not constrained by a particular time limit. Advantageously, this analytical method provides for touch-free cyanide analysis, and manipulations can be minimized and variability of measurements can be reduced.

A preferred reagent delivery device in accordance with the invention, for delivery of Konig reagents, carries a fibrous matrix having a water absorbency value (g/100 cm²) greater than 1.7, as determined by ASTM 3285 or TAPPI T441 (difference in weight of a 10×10 sheet weighed dry, and re-weighed after immersion for 10 seconds in deionized water), and a thickness greater than 0.25 mm. Beneficially, the fibrous matrix has a water absorbency value (g/100 cm²) in the range of about 1.8 to 3, and a thickness in the range of about 0.3 to 0.55 mm. A benefit is intense and complete color development of the liquid within about five minutes, ideally within about two to three minutes or less, from withdrawal of the fibrous matrix from the liquid. As a result, rapid quantitative photometric analysis is achievable. It is essential when using this fibrous matrix, that accurate, rapid cyanide analysis is not in any way prevented.

A Konig reagent delivery device in accordance with the present invention, may be a component of a test kit that beneficially includes a microcuvette useful for photometric analysis of small samples. Usefulness of such a test kit extends to the analysis of reactants that yield a cyanogen halide. For instance, the chlorine level in an aqueous sample may be analyzed by reacting the chlorine with an effective amount of a suitable water soluble cyanide to produce cyanogen chloride.

In the drawing and in detailed description of the invention that follows, there are essentially shown and described only preferred embodiments of this invention, simply by way of illustration of the best mode contemplated of carrying out this invention. As will be realized, this invention is capable of other and different embodiments, and its several details are capable of modification in various respects, all without departing from the invention. Accordingly, the drawing and the detailed description are to be regarded as illustrative in nature, and not as restrictive.

### BRIEF DESCRIPTION OF THE DRAWING

Reference is now made to the accompanying drawing, which forms a part of the specification of the present invention.

FIG. 1 is a longitudinal cross-sectional view of a first preferred reagent delivery device in accordance with the present invention;

FIG. 2 is a longitudinal cross-sectional view of a second preferred reagent delivery device in accordance with the present invention;

FIG. 3 is a perspective view of a microcuvette containing a liquid being analyzed, into which the delivery end of the reagent delivery device of FIG. 2 has been introduced;

FIG. 4 is a longitudinal cross-sectional view of another embodiment of a first preferred reagent delivery device in accordance with the present invention;

FIG. 5 is a perspective view of an illustrative photometric instrument, with a suitable microcuvette inserted in the cell chamber;

FIG. 6 is a partial, enlarged view of the instrument of FIG. 5 with the delivery end of the reagent delivery device of FIG. 2 in the microcuvette shown in FIG. 5;

FIGS. 7 to 9 show the effect on optical density from varying the molarity and molar ratio of color-forming Konig reagents; and

FIG. 10 shows the effect on completeness of color development from varying the molarity of color-forming Konig reagents.

### DETAILED DESCRIPTION OF THE INVENTION

The inventive technology is useful for the analysis of low cyanide levels, for example in the range of about 0.002 to 10 ppm, of mid-range cyanide levels, and of high cyanide levels, for example in the range of about 50 to 200 ppm or more. For analysis of cyanide levels as low as 0.002 ppm, high precision spectrophotometry should be used. Furthermore, as mentioned, a Konig Reagent delivery device in accordance with the present invention, is applicable to the analysis of reactants that yield a cyanogen halide. As pointed out, the chlorine level in an aqueous sample may be analyzed by reacting the chlorine with an effective amount of a suitable water soluble cyanide to produce cyanogen chloride. Attention is invited to the halogenation reaction details that follow, for guidance in this further application of the Konig Reagent delivery device.

In accordance with an advantageous methodology of the present invention, semi-quantitative cyanide analysis may be carried out within about two minutes or less from beginning the reaction chemistry, and quantitative cyanide analysis may be carried out within about ten minutes, desirably within about five minutes, and even more desirably within about two to three minutes or less, from beginning the color-forming reaction. If desired, the semi-quantitative analysis may be omitted. The quantitative determination may advantageously be made using spectrophotometry. Beneficially, a sample at ambient temperature may be analyzed. Accordingly, there is no need to heat a sample to an elevated temperature such as 34° C. as taught by the Essers et al prior art in order to obtain quantitative cyanide analysis in less than eight minutes.

In accordance with a beneficial inventive photometric analysis method, manipulations can be minimized and variability of measurements can be reduced. By reagent delivery using reagent delivery devices, this beneficial photometric method is touch-free. As a result, user handling of reagent solutions or pellets or powders or glass ampoules is eliminated. There are no pellets to crush or dissolve, powders to spill, glass ampoules to break, and there is no potential for injury from broken glass ampoules. Any concern about the effect of any powder spillage or loss, on precision is removed.

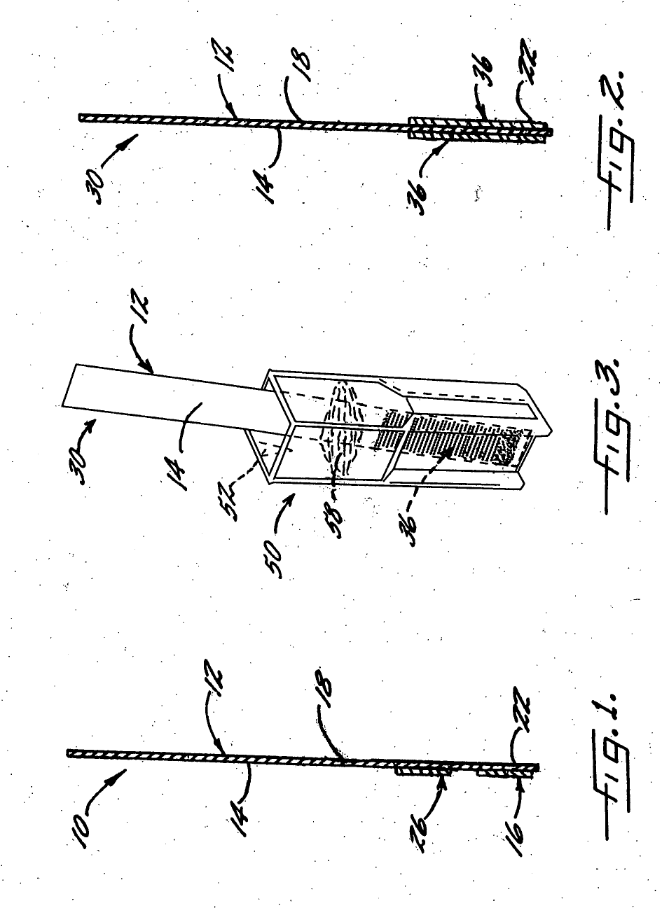

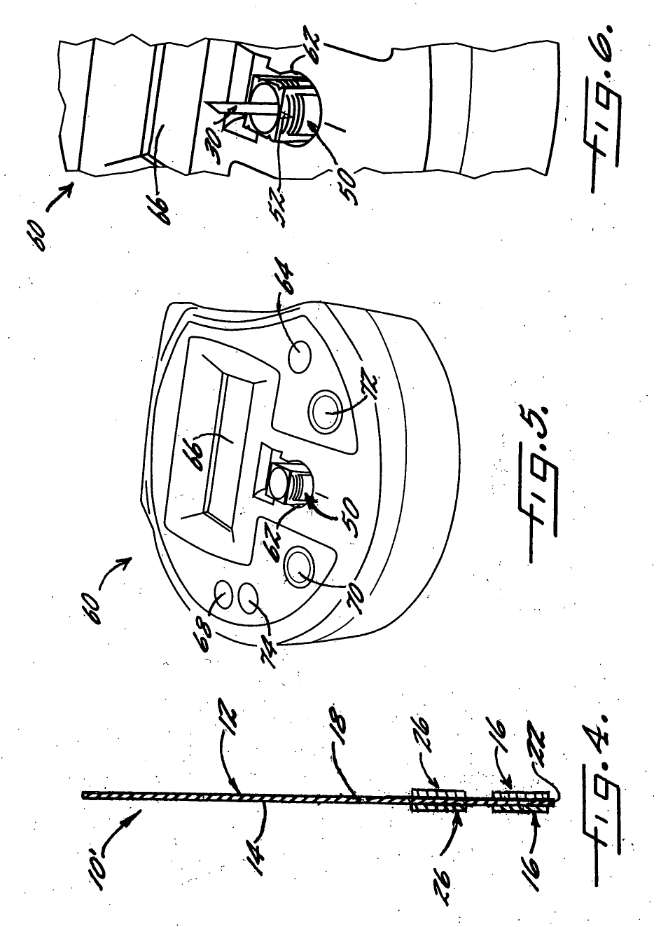

Referring to FIGS. 1 and 2 of the drawing, analytical agent delivery devices 10,30 in accordance with a preferred aspect of the present invention, are shown. Devices 10,30 conveniently each include an elongated support or handle member 12. Typically, when a plastic strip is used, the support will range in thickness from about 0.15 to 0.5 mm. In a beneficial embodiment, a sample volume of about 2 ml or less is analyzed, and to this end, use of a microcuvette is advantageous, and a practical width for support 12 will typically range from about 4 to 10 mm. The width of the support may vary from this range when a larger sample volume is analyzed, or depending upon the particular goal or goals of the cyanide analysis of interest. Similarly, the thickness of the support may be varied as desired or appropriate.

Although an elongated shape of the support is advantageous for delivery and mixing, it will be recognized that depending upon factors including the volume of sample to be analyzed, other shapes may be used for the support. The support may be made from various inert materials, with preferred materials for economy being available at low cost. Suitably, the support may be made of, for example, PVC.

An analytical agent delivery device in accordance with the present invention, beneficially provides for touch-free delivery of analytical agents for cyanide analysis into the liquid being analyzed. Conveniently, to this end and referring to FIG. 1, disposed on a first face 14 of support 12 of a preferred reagent delivery device 10, is a carrier 16 for touch-free delivery of a suitable halogenating reagent for conversion of cyanide to cyanogen halide, from which a carrier 26 is laterally spaced apart. Carrier 26 beneficially carries, and delivers into the liquid to be analyzed, a suitable water soluble buffer for providing the reaction environment with appropriate pH for conversion of cyanide to cyanogen halide and for the Konig color-forming chemistry. Conveniently, as shown, carrier 16 may be positioned near a delivery end 22 of device 10, and carrier 26 may be positioned further from delivery end 22 than carrier 16. If desired, carrier 26 may be disposed on an opposite face 18 of device 10, and likewise positioned near delivery end 22.

With reference to FIG. 2, conveniently disposed on faces 14,18 of a support 12 of a preferred reagent delivery device 30, are carriers 36 for touch-free delivery of Konig reagents for reacting with the cyanogen halide to produce a colorimetrically analyzable, colored complex. Conveniently, as shown, carriers 36 may be positioned near delivery end 22 of device 30.

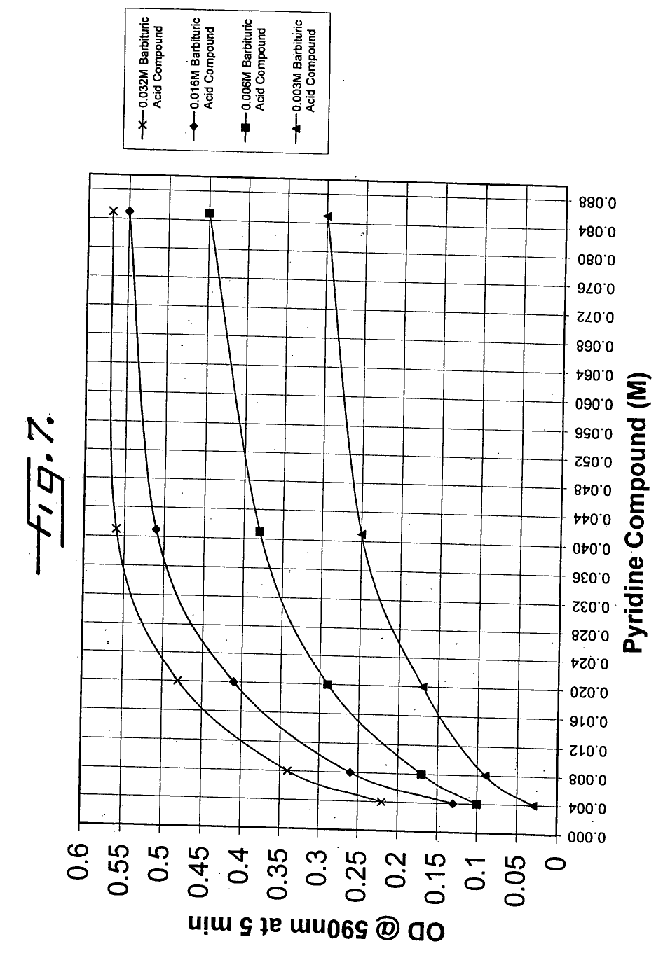

Referring to FIG. 4, a preferred analytical agent delivery device 10′ in accordance with the present invention, includes additional carriers 16,26 disposed on opposite face 18 of support 12, for increased loading and delivery of the halogenating agent and buffer. Identical numbers are used, for sake of brevity in the numbering and the description of device 10′, to indicate like parts of reagent delivery device 10′ to reagent delivery device 10 of FIG. 1.

As will be explained in more detail later, touch-free delivery of the halogenating agent and buffer, is not essential to this invention in its broadest aspects. Similarly, if semi-quantitative analysis based upon color-matching pads 36 is not desired, use of a fibrous matrix for delivery of the Konig reagents is not essential to this invention in its broadest aspects.

In any event with respect to reagent delivery devices in accordance with the present invention, it will be readily recognized that variations in the location and number of carriers on a support from those described and illustrated, can be used. Variations include fewer or more carriers disposed on a support. An additional carrier or carriers may, for example, provide increased analytical agent loading (as in the case of device 10′), provide for physical separation of agents, whether incompatible or not, or provide an additional analytical agent or agents.

Advantageously and particularly in the case of device 30 when semi-quantitative analysis based upon color-matching pads 36 thereof is desired, the carriers of a reagent delivery device in accordance with the present invention, may be water absorbent fibrous matrices that are impregnated with analytical agents and maintain structural integrity during analysis. Beneficially, for photometric analysis, a suitable fibrous matrix should be minimally linting, that is, should release few, if any, fibers into the sample.

An advantageous fibrous matrix is of appropriate thickness and water absorbency to benefit relatively higher loading, and rapid delivery, of analytical agents. A particularly useful paper for benefitting relatively higher loading and rapid delivery, will typically have a thickness greater than 0.25 mm, preferably of 0.3 mm or more, and a water absorbency value (g/100 cm²) as determined by ASTM 3285 or TAPPI T441 (difference in weight of a 10×10 sheet weighed dry, and re-weighed after immersion for 10 seconds in deionized water) greater than 1.7, beneficially in the range of about 1.8 to 3. Materials useful as suitable fibrous matrices include filtration materials that include cellulosic and synthetic fibers.

A useful cellulosic filtration material for use in this invention when the carriers are fibrous matrices, is illustrated by, but not limited to, Schleicher and Schuell (S&S) 404 paper. This type of useful paper is typically characterized by a thickness of about 0.2 mm or less, and a water absorbency value of 1.2 to 1.5 g/100 cm². For example, S&S 404 paper has a water absorbency value of 1.4 g/100 cm².

Especially beneficial filtration materials when relatively higher loading of, and rapid delivery from, fibrous matrices is desired, are illustrated by, but not limited to, S&S 8S paper, a rayon paper, and Lohmann Vliesstoffe OL 50 paper, a viscose rayon paper. This type of beneficial paper is characterized by a thickness of about 0.3 mm or more, and a water absorbency value (g/100 cm²) of 1.8 or more. For example, S&S 8S paper is characterized by a thickness of about 0.35 mm and a water absorbency value of about 2.4 g/100 cm², and OL 50 paper is characterized by a thickness of about 0.4 mm.

By the term “rapid delivery” is meant, for purposes of this invention with respect to a Konig reagent delivery device such as device 30, delivery of an appropriate molarity of each Konig reagent so that meaningful quantitative colorimetric evaluation of the liquid color can be carried out within about five minutes, and desirably within about two to three minutes or less, from withdrawing the Konig reagent delivery device from the liquid being analyzed. By the term “meaningful” in this context, is meant that color development is substantially complete within the specified period of time. By the term “substantially” in this context, is meant that color development is at least 95% complete. Beneficially, substantially intensified color development of the liquid being analyzed, is obtained compared to color development when using a type of reagent delivery medium as exemplified by S&S 404 paper.

The carriers of analytical agent delivery devices in accordance with the present invention, are beneficially impregnated with, or otherwise carry, a plurality of water soluble agents for cyanide analysis. A suitable carrier loading of a particular analytical agent will vary depending upon factors including the particular analytical agent selected, and the cyanide concentration and volume of the liquid to be analyzed. Thus, for example, a relatively higher cyanide concentration or relatively greater sample volume can generally be expected to require a relatively higher carrier loading of the halogenating agent and buffer, as well as a relatively higher loading of the Konig reagents, whereas a relatively lower carrier loading of the halogenating agent and buffer, as well as of the Konig reagents, is appropriate for a relatively lower cyanide concentration or relatively smaller sample volume. In any event, reagent delivery devices in accordance with the invention, carry and deliver into a liquid being analyzed, effective amounts of these analytical agents for the cyanide analysis of interest.

When a fibrous matrix carrier is used, an impregnation solution containing an appropriate concentration of the analytical agent (or agents), should be used to obtain the desired loading. However, consideration must be given to factors such as the water solubility of a particular analytical agent, and the thickness of a particular fibrous matrix. For example, chloramine-T has a maximum water solubility at ambient temperature of about 15 wt. %. Limiting factors such as these, may be overcome by providing a support with increased length and/or width of a fibrous matrix, as illustrated by device 10′, which uses two pads 16,26, and thus a double length of pads 16,26.

In accordance with preferred reagent delivery devices 10 and 10′, pad (or pads 16) of support 12 thereof carries, and delivers into a liquid to be analyzed, an effective amount of a suitable water soluble halogenating agent for converting cyanide to cyanogen halide. Suitable halogenating agents capable of reacting with cyanide to yield cyanogen halide as a reaction intermediate are well known in the prior art, and include, but are not limited to, chlorinating agents such as chloramine-T and sodium hypochlorite, which are generally used. Also useful is dichloroisocyanuric acid, as well as N-chlorosuccinimide stabilized with excess succinimide. A useful brominating agent is a mixture of 82.5% sodium dichloro-s-triazinetrione, and 14.7% sodium bromide, which is commercially available from Bio-Lab, Inc. of Decatur, Ga.

A carrier loading of about 0.02 g chloramine-T may be used for a 2 ml sample having a low to mid-range cyanide level. On the other hand, a greater carrier loading of about 0.04 g chloramine-T may be beneficial for a like sample volume but having a high cyanide level. An impregnation solution prepared by dissolving 1.15 g of 82.5% sodium dichloro-s-triazinetrione and 14.7% sodium bromide in 17.74 g of deionized water (pH 6.3), may be used to load carrier 16, with a suitable level of brominating agent.

Using a chloramine-T solution for a 10 ml sample containing less than 5 μg of cyanide, about 0.001 to 0.003 g of chloramine-T (0.1 to 0.3 ml of a 1% w/v of chloramine-T) solution may be used. Thus, chloramine-T delivery of 0.003 g or less may be adequate for a sample of from about 1 to 10 ml containing a low cyanide level. When using 0.5% sodium hypochlorite solution, guidance as to a suitable amount of the sodium hypochlorite solution, is provided in the referenced Chemetrics, Inc. prior art and in Example 6.

Beneficially, the halogenating agent reacts with cyanide in an acidic reaction environment to yield cyanogen halide. The halogenating reaction environment pH is believed to be significant not only in regard to promoting complete and rapid conversion of cyanide to cyanogen halide but also for minimizing cyanogen halide degradation. An advantageous reaction environment acidity for the halogenating reaction is an elevated acidic pH significantly greater than pH 2, beneficially in the range of from about 3 to less than 7, preferably about 5 to 6 to promote rapid conversion of cyanide to cyanogen halide and minimize cyanogen halide degradation. A reaction environment pH for the halogenating reaction greater than 7.5, is typically detrimental.

Likewise, the reaction environment pH for reaction of the Konig reagents with the cyanogen halide to produce a colorimetrically analyzable, colored complex is significant for optimum color development and speed of color development. In this regard, an advantageous final pH for the Konig Reaction is an elevated pH significantly greater than pH 3, beneficially in the range of from about pH 4 to 7.5 and preferably about pH 5.5 to 6.5 depending upon the Konig reagents selected and the buffer selected. In this regard, attention is invited to the earlier discussion of the Bradbury prior art. A final pH substantially below 4 or substantially in excess of pH 7.5 is typically detrimental for optimum color development and speed of color development.

In accordance with preferred reagent delivery devices 10 and 10′, support 12 thereof carries, and delivers into a liquid to be analyzed, an effective amount of a suitable water soluble buffer for controlling the reaction environment pH for the halogenating reaction and the reaction environment pH for the Konig Reaction to each be an appropriate elevated pH. Beneficial water soluble buffers are known in the prior art, and include, but are not limited to, phosphate and acetate buffers, including modified phosphate buffers.

For phosphate buffers, an alkali metal phosphate monobasic salt and alkali metal phosphate dibasic salt may be combined in appropriate relative proportions depending upon the buffer pH desired. Sodium and potassium alkali metal salts are commonly used. When a buffer pH of about 4 is desired, the monobasic salt may be used alone. When a buffer pH less than 4 is desired, the monobasic salt may be combined with an appropriate proportion of a suitable acidifying organic acid such as malic acid.

For acetate buffers, sodium acetate and acetic acid may be combined in appropriate relative proportions depending upon the buffer pH desired. A citrate buffer may also be used, in which case citric acid and sodium citrate may be combined in appropriate relative proportions.

Whether the buffer is delivered from a reagent delivery device in accordance with the present invention, or is delivered in solution form or otherwise, a selected ratio, in the case of a phosphate buffer, of an alkali metal phosphate monobasic salt to alkali metal phosphate dibasic salt, and including as necessary an appropriate acidifying organic acid, is prepared, with the ratio selected driven by the desired pHs. An illustrative ratio, on a weight percent basis, for a buffer pH of 4.7, is as exemplified by Example 1, about 6:1 of phosphate monobasic to dibasic salt. For delivery in solution form or for impregnation of a fibrous matrix carrier, the buffer constituents may be dissolved conveniently in deionized water.

As can be recognized, a suitable amount of the buffer to be delivered into the liquid to be analyzed, will vary depending upon factors including the sample pH, and the acidity or alkalinity, and loading of the other analytical agents including in particular the Konig Reagents. In the case of impregnating a fibrous matrix, attention is invited to Examples 1 and 5, which should in no way be regarded as limiting, for guidance in loading a carrier with a suitable amount of buffer. When delivering the buffer as a liquid, guidance as to a suitable amount of buffer, is provided in the referenced prior art and in Example 6. In any event, the amount of buffer delivered is sufficient to control the reaction environment pH for the halogenating reaction to be an elevated acidic pH beneficially in the range of from about pH 3 to less than pH 7, and to control the reaction environment pH for the Konig Reaction so that the final pH is an elevated pH beneficially in the range of from about pH 4 to 7.5 depending upon the Konig reagents selected and the buffer selected.

In accordance with preferred reagent delivery device 30, support 12 thereof carries, and delivers into a liquid being analyzed, an effective amount of a mixture of suitable Konig Reaction reagents. Suitable Konig Reaction reagents include cyanogen halide-reactive pyridine compounds for providing a Konig Reaction intermediate, and barbituric acid compounds for reacting with the Konig Reaction intermediate to yield a colorimetrically analyzable, colored complex. Beneficially for delivery from a fibrous matrix, solids, not liquids, are selected as Konig Reaction reagents. A further advantage can be increased stability and shelf life in a dry, rather than liquid or wet, state.

Pyridinium salts, and pyridine derivatives such as isonicotinic acid, isonicotinamide, nicotinic acid, and pyridine-3-nitrophthalic acid, exemplify beneficial pyridine compounds. Barbituric acid and barbituric acid derivatives such as 1,3-dimethylbarbituric acid exemplify beneficial barbituric acid compounds. Also useful according to the prior art, are other barbituric acid derivatives such as thiobarbituric acid derivatives as exemplified by 1,3-diethyl-2-thiobarbituric acid.

Differences in color-forming effectiveness and hence analysis sensitivity, and in color-forming reaction speed, exist among the various pyridine compounds and among the various barbituric acid compounds. For example, isonicotinamide may be expected to be more sensitive than nicotinic acid, and 1,3-dimethylbarbituric acid may be expected to be more sensitive than barbituric acid.

Beneficially, the Konig reagents are used in a water soluble form. Thus, for instance, an alkali metal salt, conveniently a sodium salt, of a carboxylated pyridine compound such as isonicotinic acid, and of a barbituric acid compound, may be used. Likewise, as earlier indicated, a water soluble pyridinium salt such as pyridinium trifluroacetate, may be used.

A suitable level of the Konig reagents and the relative molar ratio of the Konig reagents selected, will vary depending upon factors including the cyanide concentration, the Konig reagents selected, the optical density desired, the desired speed of the color-forming reaction, and the sample volume. In the case of a reagent delivery device in a accordance with the present invention, a relatively greater loading, accompanied by rapid delivery, of the Konig reagents, has been found to benefit optimum color development and the speed of color development. Consistent with this finding, to benefit color development and the speed of color development in the case of low cyanide concentration, a relatively weaker Konig reagent requires a relatively greater loading of the Konig reagent, whereas a relatively lower loading of a relatively stronger Konig reagent may be used. On the other hand, for high cyanide concentration, it may be desirable to use a relatively weaker Konig reagent or reagents so as to obtain appropriate color development for colorimetric evaluation.

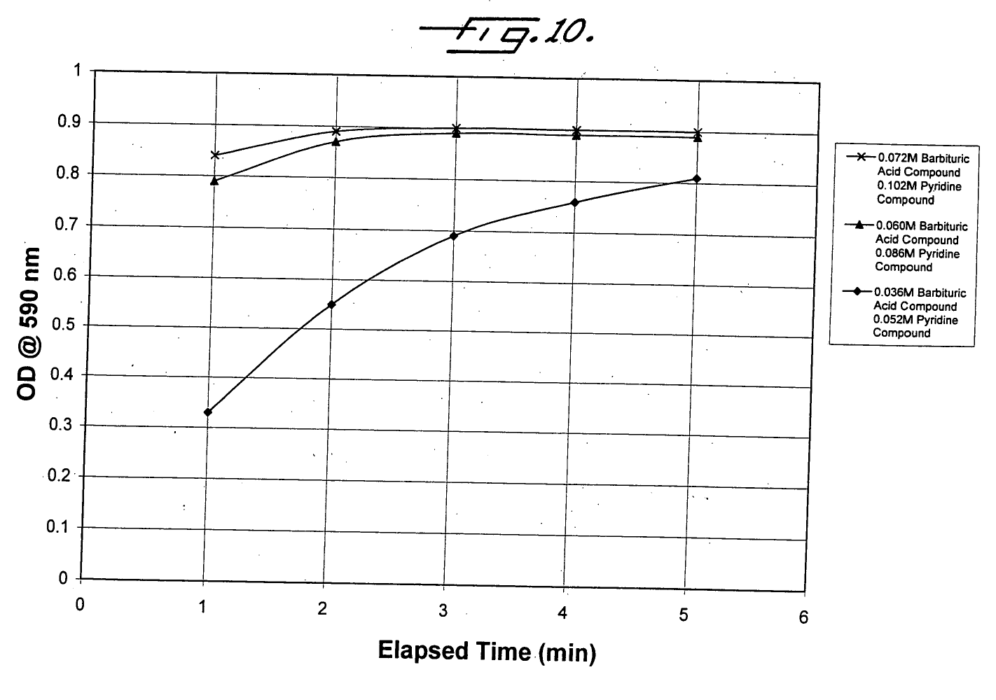

It has been found that optimization of color development is related to the molarity of the Konig reagents, and, in addition, to the relative ratio, on a molar basis, of the Konig reagents selected. Thus, it has been observed that for a particular molarity of a Konig pyridine compound, increased color intensity may be expected as the molarity of a Konig barbituric acid compound increases, until as clearly illustrated in FIG. 9, decreased color intensity may be expected as a result of an excessive molar ratio of the Konig barbituric acid compound to the Konig pyridine compound.

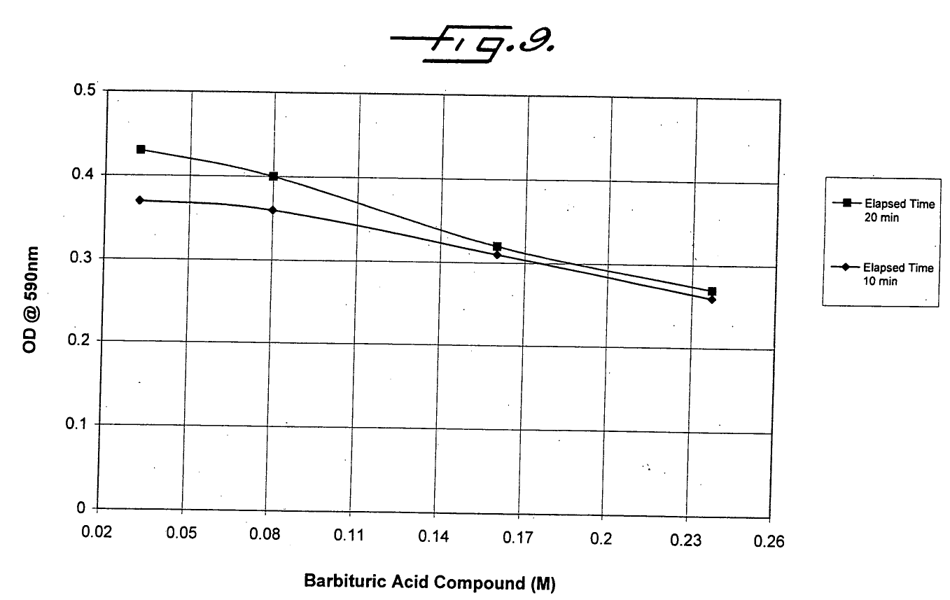

Referring specifically to FIGS. 7-9 and related Examples 6 and 7, it may be expected that for a particular sample volume and cyanide concentration, once an appropriate molarity of a Konig pyridine compound is selected for optimizing color intensity, that a relative ratio, on a molar basis, of Konig pyridine compound to Konig barbituric acid compound in the range of from about 5:1 to 0.5:1, advantageously about 2:1 to 1:1, will generally be consistent with optimizing color intensity. On the other hand, for the particular molarity of Konig pyridine compound, an increase in the relative ratio, on a molar basis, of the Konig barbituric acid compound beyond the optimized molar ratio range may be expected to result in decreased color intensity.

Illustrative and providing guidance in the selection of appropriate Konig reagent molarities, and an appropriate optimizing relative molar ratio, when a 2 ml sample volume containing a low cyanide concentration is being analyzed, are FIGS. 7 to 9 and related Examples 6 and 7.

Similarly, it has been observed that for a particular molarity of Konig barbituric acid compound, an increase in the molarity of Konig pyridine compound may be expected to increase color intensity until no further increase in color intensity may be expected. Exemplary and providing guidance for optimizing color intensity when selecting appropriate Konig reagent molarities, and an appropriate relative molar ratio, when a 2 ml sample volume containing a low cyanide concentration is being analyzed, are FIGS. 7 and 8 and related Example 6.

Attention is invited to Example 1 (2 ml sample volume), which should in no way be regarded as limiting, for guidance in loading a fibrous matrix with suitable molar amounts of Konig reagents. As can be appreciated, considerations such as a significantly greater sample volume than 2 ml, will guide the selection of relatively increased amounts of the Konig reagents for the optimization of color intensity. As indicated in Example 2, a like procedure was followed for impregnation of S&S 8S paper with Konig reagents to provide a reagent delivery device that in accordance with a preferred aspect of the invention, provides for rapid delivery of Konig reagents.

If appropriate or desired, carriers of an inventive reagent delivery device may be impregnated with or otherwise carry, one or more other agents such as dispersing or wetting agents, that may be of benefit for the cyanide analysis. To be used in the subject invention, an agent or material cannot interfere with test accuracy or, when rapid cyanide analysis is the objective, prevent rapid cyanide analysis. By “rapid cyanide analysis” is meant, for purposes of this invention, meaningful quantitative colorimetric evaluation of the liquid color within about five minutes, and desirably within about two to three minutes or less, from withdrawing the Konig reagent delivery device from the liquid being analyzed.

Fibrous matrix impregnation may be accomplished in any of several ways. A suitable way is to pass a carrier material through an impregnation bath containing the particular chemicals so that the carrier becomes saturated with the impregnation solution. The carrier may be then dried at room temperature or at an elevated temperature. Advantageously, the concentration of the chemicals in an impregnation solution and the fiber mass and the residence time of the carrier material in the solution are selected to ensure impregnation of an appropriate loading. Generally speaking, residence time will vary from about two to forty seconds, depending upon the loading desired and the carrier. If desired or appropriate, the carrier may be dipped more than once to increase the loading.

Separate impregnation solutions are beneficially used for the halogenating agent, for the buffer, and for the Konig reagents. In accordance with preferred reagent delivery devices 10,10′, the halogenating agent and the buffer are beneficially delivered from a common support so that an appropriate acidic reaction environment is provided for cyanide conversion to a cyanogen halide.

Conveniently, fibrous pads may be attached to the support in a variety of ways. A suitable conventional method is by use of a double-faced adhesive-material.

In accordance with a highly beneficial inventive rapid delivery method, a medium for carrier 36 is selected to provide delivery of an appropriate molarity of each Konig reagent rapidly enough for meaningful quantitative colorimetric liquid analysis within about 2 minutes or less from withdrawing support 12 from the liquid being analyzed. Thus, retarding Konig reagent delivery using a water soluble embedding polymer as taught by examples of Fisher et al that specify waiting times of 3 minutes or more for color development, would be contrary to this highly beneficial inventive rapid delivery method.

Although a smaller sample volume may be used, a preferred sample volume for the inventive technology is about 2 ml or less. A greater sample volume may, if desired, be used; however, as sample volume is increased, considerations such as increased reagent amounts should be taken into account to maintain maximum color development in the desired period of time.

Prior to or in preparation for analysis, a sample may be prepared by conventional procedures that liberate free cyanide from a cyanide complex. Sample pH should be known or determined, and if not acceptable, the sample pH should be appropriately adjusted. A sample pH in the range of about 5 to 11, is typically preferred for the analysis.

In carrying out the inventive technology when reagent delivery devices 10,30 are beneficially used, delivery of analytical agents from reagent delivery device 10 precedes delivery of analytical agents from reagent delivery device 30. In each case, the device delivery end is dipped in the liquid being analyzed, and moved within the liquid to assist delivery and mixing of the analytical agents and liquid. The delivery end may be moved in a variety of useful ways to promote delivery of the analytical agents into the liquid, and a mixing action. During the conversion of cyanide to cyanogen halide, it is beneficial to minimize introducing air into the liquid. Thus, a mixing action consistent with minimizing unwanted interference with quantitative conversion of cyanide to cyanogen chloride, should be used. Accordingly, a mixing action such as vigorously shaking a sample, should be avoided.

Referring to FIG. 3 and illustratively to device 30, for a 2 ml liquid sample (in FIG. 3, the liquid is indicated by the numeral 58), a microcuvette such as microcuvette 50, is advantageous, and an up-and-down movement is practical in producing repeated immersion of pads 36 of device 30 in liquid 58 in the microcuvette; and a constant, gentle motion at a rate of about one up-and-down stroke per second, is typically advantageous. For a larger volume, a larger cuvette or sample container can be used, and other types of appropriate mixing actions are practical.

The time of contact of the liquid being analyzed with a reagent delivery device in accordance with the present invention, is selected to provide sufficient time for analytical agent delivery, it being recognized that depending upon the loading of a particular analytical agent and other factors including the level of cyanide and the desired analysis speed, it may not be necessary or desirable for complete analytical agent delivery to be effected. Other considerations affecting the time of contact include the temperature of the liquid and, as previously described, the carrier medium selected. In this regard, a relatively shorter contact time may be used for a carrier medium that delivers the analytical agents relatively more rapidly, whereas a carrier medium that delivers the analytical agents relatively more slowly is benefitted by a relatively longer contact time. A preferred contact time for a reagent delivery device in accordance with the invention, whether delivering a halogenating reagent, buffer or Konig reagents, is generally less than one minute from immersing the delivery end in the liquid so that analytical agent delivery commences, with a shorter contact time in the range of about ten to thirty seconds being typically appropriate depending upon factors including the reagent loading and the carrier medium. If desired or appropriate, a longer contact time may be used.

Whether the halogenating reagent and buffer are delivered from a reagent delivery device or in liquid form, less than one minute will generally be sufficient from beginning the conversion of cyanide to cyanogen chloride, to proceeding to the Konig Reaction.

After the selected contact time of reagent delivery device 10, device 10 is withdrawn from the liquid, and thereafter reagent delivery device 30 is dipped in the liquid as previously described. After the selected contact time, reagent delivery device 30 is withdrawn from the liquid, and, when a fibrous matrix carrier is used, it has been surprisingly found that the color of the fibrous pads may advantageously be evaluated with semi-quantitative results, although color development of the liquid may continue. The fibrous pad color may be evaluated by color matching using an appropriately calibrated color chart. Fibrous pad color matching may advantageously be immediate. Otherwise, a waiting period may be appropriate.

Color development of the liquid, regardless whether the Konig reagents are delivered in accordance with the invention from a reagent delivery device or are delivered in solution form, may continue for up to about two minutes or even up to 20 minutes or more depending upon factors including the Konig reagents used, the concentration and relative molar ratio of the Konig reagents in the liquid, the final pH, and the temperature of the liquid being analyzed. When using a preferred methodology in accordance with the present invention, color development of the liquid may advantageously be at least 90% complete, beneficially at least 95% complete, within about 10 minutes, desirably within about 5 minutes, even more desirably within about 1 to 3 minutes, from withdrawing reagent delivery device 30 from the liquid being analyzed.

The reaction chemistry is temperature sensitive in that increase in the temperature of the liquid being analyzed, increases the rate of color development. For example, when the methodology provides substantially complete color development at about the 10 minute interval when the liquid temperature is about 20-28° C.; about 20-25 minutes or more will be needed when the liquid temperature is about 15-19° C.; and about 40-50 minutes or more will be needed when the liquid temperature is about 5-14° C.

Evaluation of the liquid color may be carried out visually or photometrically. Visual evaluation uses color matching and a standard color chart, with the color beneficially being viewed from above through the length of the liquid column against the various color boxes of the color chart. Visual evaluation provides a semi-quantitative result.

For quantitative results, photometric analysis is advantageous. Suitable photometric cells may be made of glass or plastic. Useful photometric instruments are commercially available. An appropriate wavelength for a particular photometric analysis, depends upon the color-forming chemistry. Photometric cells having a light path of 1 cm or longer are typically used for analysis of low cyanide levels. A shorter light path may be considered for analysis of high cyanide levels. As described in the Examples that follow, optical density values may be adjusted to take into consideration any background optical density. When using semi-quantitative evaluation by visual color matching, any reasonable level of solids in the liquid being colorimetrically evaluated, would typically not interfere with the evaluation.

Referring to FIG. 5, in a beneficial inventive photometric method, an about 2 ml aqueous sample is added to microcuvette 50, the properly dimensioned microcuvette is inserted into a cell chamber 62 of an illustrative spectrophotometer 60, and photometer 60 is zeroed. Beneficial photometer features include a power button 64, a display 66, a touch pad 68 for selecting whether percent transmission or optical density is displayed, a touch pad 70 for zeroing the photometer, a touch pad 72 for display of analytical readings, and a touch pad 74 for continuous readout of changes in absorbance. A wavelength appropriate for the color-forming chemistry, is used for the analysis.

Thereafter, with microcuvette 50 remaining in photometer 60, delivery end 22 of reagent delivery device 10 (shown in FIG. 1) is introduced into the sample and moved as previously described, for an appropriate period of time (all pads repeatedly immersed during the selected contact time) as described, to deliver a plurality of analytical agents from a common support and mix the analytical agents and sample. Beneficially, the reaction environment is appropriately buffered and rapid conversion of cyanide to cyanogen halide is promoted.

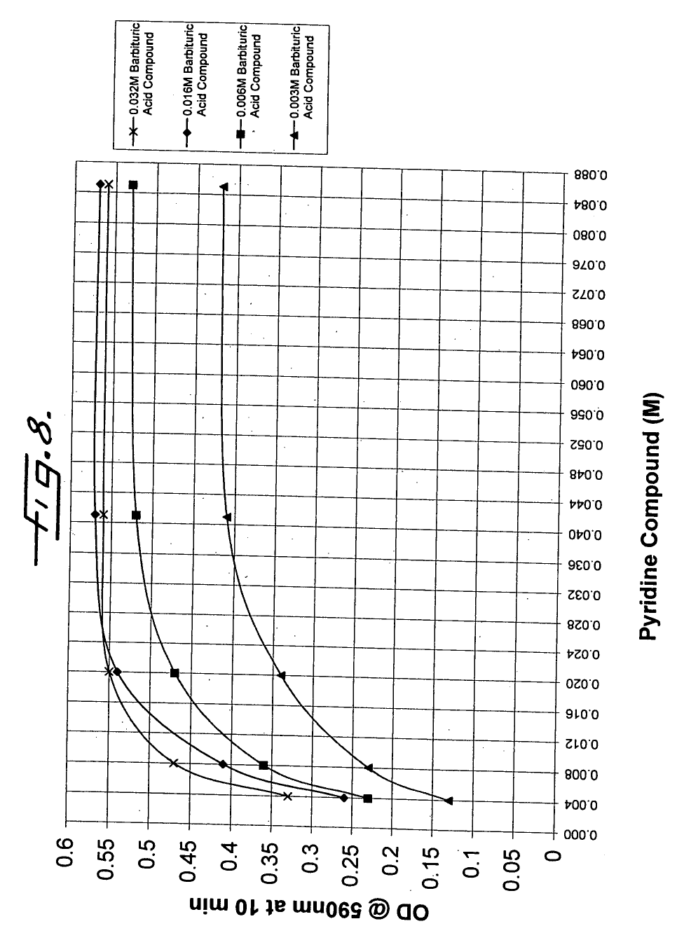

Thereafter, reagent delivery device 10 is withdrawn from the sample, and referring now to FIG. 6, advantageously within a short period of time, for example within about 10 seconds when complete conversion of cyanide to cyanogen halide has occurred during the period of time allowed for contact of device 10 with the sample, the delivery end of reagent delivery device 30 is introduced into the sample and moved as previously described, for an appropriate period of time (all pads repeatedly immersed during the selected contact time) as previously described, to deliver the Konig reagents from a common support and provide a mixing action.

Advantageously, as previously described, when a fibrous matrix carrier is used, the color of pads 36 of device 30 may be immediately evaluated. If needed, an appropriate waiting time should be allowed. Color development of the liquid is allowed to continue for an appropriate period of time as previously described.

When color development is at least substantially complete, and with touch pad 68 having been pressed for display of optical density readings, touch pad 72 is pressed to display the optical density of the liquid color.

As indicated, other reagent delivery devices in accordance with the present invention, may be used in the inventive photometric method, in place of devices 10,30.

In a particularly beneficial application of the inventive photometric method, the microcuvette is advantageously not removed or disturbed after being inserted in the photometer for zeroing the sample and microcuvette, until removal after a desired reading or readings. As indicated in FIG. 6, a marking 52 (also shown in FIG. 3), on the microcuvette is useful for guiding appropriate orientation of the microcuvette in the photometer. Blanking of a sample and microcuvette, analytical agent delivery and mixing, and photometric analysis may all be carried out in the same microcuvette quickly and efficiently. This methodology avoids concerns about reproducibility due to microcuvette OD variability, or smudges or fingerprints or water drops on microcuvettes as a result of microcuvette removal and re-insertion.

Throughout this description which includes the Examples that follow, all parts and percentages are weight percent unless otherwise specified. Unless otherwise indicated in the Examples that follow, a CO7500 Colorimeter available from Industrial Test Systems, Inc., Rock Hill, S.C., is used for spectrophotometric analysis, and a wavelength of 590 nm is used. The CO7500 Colorimeter provides a maximum OD reading of 2.00.

### EXAMPLE 1

With reference again to reagent delivery device 10 of FIG. 1, in a convenient embodiment, support 12 is made of PVC, is 8 mm wide and has a thickness of 0.009 inches, and carriers 16,26 are each ½″ long and 8 mm wide. Carriers 16,26 are fibrous pads made of Schleicher and Schuell (S&S) 404 paper, and are attached near support end 22 by double-faced adhesive to face 14 of the support. To prepare pad 16, a 13 wt. % solution of chloramine-T hydrate in deionized water having a pH of 9.7, is used to impregnate S&S 404 paper. To prepare pad 26, a solution of 32.9 wt. % sodium phosphate monobasic and 5.6 wt. % sodium phosphate dibasic in deionized water having a pH of 4.7, is used to impregnate S&S 404 paper. S&S 404 paper has a thickness of approximately 0.2 mm, a water absorbency value of 1.4 g/100 cm², and a basis weight of approximately 80 g/cm².

With reference again to reagent delivery device 30 of FIG. 2, in a convenient embodiment, support 12 is as previously described, and carriers 36 are each 1″ long and 8 mm wide. Carriers 36 are fibrous pads made of Schleicher and Schuell (S&S) 404 paper, and are attached near support end 22 by double-faced adhesive to opposite faces 14,18 of the support. To prepare pads 36, a solution of 12.8 wt. % 1,3-dimethylbarbituric acid, 14.4 wt. % isonicotinic acid and 5.7 wt. % sodium hydroxide having a pH of 6.4, is used to impregnate S&S 404 paper.

A cyanide standard (sodium cyanide) having a concentration of approximately 0.5 ppm cyanide, is prepared using water free of chlorine and cyanide. The pH is adjusted to 11 using sodium hydroxide solution.

2 ml of the cyanide standard at a temperature of approximately 72° C., is added to microcuvette 50 (shown in FIG. 3). Then delivery end 22 of reagent delivery device 10 is dipped in the 2 ml cyanide standard for 30 seconds to repeatedly immerse carrier pads 16,26 so that the pH is appropriately buffered and cyanide is converted to cyanogen chloride. An up-and-down motion of reagent delivery device 10 is used to deliver the analytical agents from pads 16,26 and provide a mixing action. The up-and-down motion is at a gentle constant rate of approximately one up-and-down motion per second.

Immediately after the 30 seconds contact time with the 2 ml volume of cyanide standard, device 10 is withdrawn from microcuvette 50, and referring again to FIGS. 2 and 3, beginning within 10 seconds, delivery end 22 of reagent delivery device 30 is dipped in the liquid in the microcuvette for 30 seconds to repeatedly immerse carrier pads 36. As before, an up-and-down motion at a gentle constant rate of approximately one up-and-down motion per second, is used to deliver the analytical agents from pads 36 and provide a mixing action.

Immediately after the 30 seconds contact time with the liquid in the microcuvette, device 30 is withdrawn from the microcuvette, and the color of test pads 36 is immediately visually evaluated by color matching using a color chart calibrated for S&S 404 paper. A semi-quantitative, but accurate, cyanide value of 0.5 ppm is determined.

After allowing color development of the liquid in the microcuvette for 3, 5 and 10 minutes from withdrawal of reagent device 30, the microcuvette is inserted into the cell chamber of a CO7500 Colorimeter, and the respective OD readings at the 3, 5 and 10 minute intervals are as follows (the photometer is first zeroed using another microcuvette containing 2 ml of a water sample free of cyanide): 0.31, 0.49 and 0.67. The increase in OD from the 3 minute to the 10 minute interval, indicates continuation of the color development. A final pH of 6.8 is measured at the 10 minute interval.

Repeat of the method of this Example but modified by using 2 ml of a water sample free of cyanide, reveals 3, 5 and 10 minute OD readings as follows: 0.10, 0.12 and 0.12. These readings indicate “background” OD, which needs to be taken into account when highly accurate readings are desired. Linting by loss of fibers from the S&S 404 pads attributable to the particular analytical chemistry, may contribute to the “background” OD. Adjustment for the “background” OD, yields 3, 5 and 10 minute OD readings as follows: 0.21 (0.31-0.10), 0.37 (0.49-0.12) and 0.55 (0.67-0.12).

Alternatively, the liquid color may be evaluated semi-quantitatively at the 3, 5 and 10 minute intervals by color matching using the color chart, by being beneficially viewed from above through the length of the liquid column against the various color boxes of the color chart.

### EXAMPLE 2

In this Example, reagent delivery devices 10,30 substantially correspond to those used in Example 1, except that S&S 8S paper is impregnated instead of S&S 404 paper, and used for carriers 36 of device 30. S&S 8S paper has a thickness of approximately 0.35 mm, a water absorbency value of approximately 2.4 g/100 cm², and a basis weight of approximately 50 g/cm² The method of Example 1 is repeated using another 2 ml of the same cyanide standard.

Visual evaluation of the color of test pads 36 as before, and using the color chart calibrated for S&S 404 paper, reveals an intensified color and results in a determination of a cyanide value of 1.0 ppm. This elevated cyanide value indicates greater sensitivity using S&S 8S paper, instead of S&S 404 paper; and as can be understood by one skilled in the art, an accurate cyanide value of 0.5 ppm would be shown by a color chart calibrated for S&S 8S paper.

As before, after allowing color development of the liquid in the microcuvette for 3, 5 and 10 minutes from withdrawal of reagent device 30, the color of the liquid in the microcuvette is photometrically evaluated, and the respective OD readings are as follows: 0.79, 0.82 and 0.82. A final pH of 6.6 is measured.

Repeat of the method of this Example but modified by using 2 ml of a water sample free of cyanide, produces 3, 5 and 10 minute OD readings as follows: 0.17, 0.19 and 0.19. These readings reveal higher background OD than observed in Example 1. Linting by loss of fibers from the S&S 8S pads may contribute to the higher background OD. Adjustment for the background OD yields 3, 5 and 10 minute OD readings as follows: 0.62 (0.79-0.17), 0.63 (0.82-0.19) and 0.63 (0.82-0.19).

The higher OD readings obtained by this Example compared to those of Example 1, confirm enhanced color development and significantly greater sensitivity using S&S 8S paper compared to S&S 404 paper. In addition, the OD readings demonstrate that color development is substantially complete within 3 minutes and accordingly increased speed of color development, using S&S 8S paper.

### EXAMPLE 3

In this Example, reagent delivery devices 10,30 substantially correspond to those used in Example 1.

In an application of the preferred photometric method and referring to FIGS. 5 and 6, another 2 ml of the same cyanide standard is added to another microcuvette 50, and the outside of microcuvette 50 is wiped to be clean and dry. Referring particularly to FIG. 5, the microcuvette is then inserted into the cell chamber of a CO7500 Colorimeter using mark 52 (shown in FIG. 6) as a guide, and photometer 60 is zeroed.

Thereafter, with microcuvette 50 remaining in photometer 60, the delivery end of reagent delivery device 10, is dipped repeatedly in the 2 ml cyanide standard as in Example 1, to deliver the analytical agents from pads 16,26 and provide a mixing action. Immediately after 30 seconds contact time with the 2 ml volume of cyanide standard, device 10 is withdrawn from microcuvette 50, and referring particularly to FIG. 6, beginning within 10 seconds, the delivery end of reagent delivery device 30 is dipped repeatedly in the liquid in microcuvette 50 as in Example 1, to deliver the analytical agents from pads 36 and provide mixing.

As in Example 1, immediately after 30 seconds contact time with the liquid in microcuvette 50, device 30 is withdrawn from microcuvette 50, and the color of test pads 36 is visually evaluated by color matching using the color chart calibrated for S&S 404 paper. A semi-quantitative, but accurate, cyanide value of 0.5 ppm is determined.

As before in Example 1, after allowing color development of the liquid in microcuvette 50 for 3, 5 and 10 minutes from withdrawal of reagent device 30, the color of the liquid in microcuvette 50 is photometrically evaluated, and the respective OD readings are as follows: 0.28, 0.42 and 0.63. The increase in OD from the 3 minute to the 10 minute interval, indicates continuation of the color development. A final pH of 6.8 is measured after the 10 minute interval.

As may be understood, in this preferred photometric method, the microcuvette remains in the photometer during an entire analysis procedure after insertion of the microcuvette and the cyanide standard for zeroing the instrument, until removal after a desired reading or readings. As a result, concerns about reproducibility due to microcuvette OD variability, or smudges or fingerprints or water drops on microcuvettes as a result of microcuvette removal and re-insertion, are eliminated. Consequently, it is expected that the unadjusted OD readings obtained by the preferred photometric method of this Example are more accurate than the unadjusted OD readings obtained in Example 1.

Even so, when highly accurate readings are desired, background OD needs to be taken into account as in Examples 1 and 2. Repeat of the method of this Example but modified by using 2 ml of a water sample free of cyanide, reveals 3 and 5 minute background OD readings as follows: 0.10 and 0.10. Adjustment for the background OD yields 3 and 5 minute OD readings as follows: 0.18 (0.28-0.10) and 0.32 (0.42-0.10).

### EXAMPLE 4

In this Example, reagent delivery devices 10,30 substantially correspond to those used in Example 2 (S&S 8S paper for pads 36 of device 30), and the preferred photometric method of Example 3 is repeated using another 2 ml of the same cyanide standard.

Visual evaluation of the color of test pads 36 as in Example 3, and using the color chart calibrated for S&S 404 paper, reveals an intensified color and results in a determination of an elevated cyanide value of 1.0 ppm (as in Example 2). As before, after allowing color development of the liquid in microcuvette 50 for 3 and 5 minutes from withdrawal of reagent device 30, the color of the liquid in microcuvette 50 is photometrically evaluated, and the respective OD readings are as follows: 0.86 and 0.87. A final pH of 6.6 is measured. As in the case of Example 3, it is expected that the OD readings obtained by this preferred photometric method, are more accurate than those obtained in Example 2.

Even so, when highly accurate readings are desired, background OD needs to be taken into account. Repeat of the method of this Example but modified by using 2 ml of a water sample free of cyanide, reveals 3 and 5 minute OD readings as follows: 0.14 and 0.14. Adjustment for the background OD yields 3 and 5 minute OD readings as follows: 0.72 (0.86-0.14) and 0.73 (0.87-0.14).

### EXAMPLE 5

Referring to FIG. 4, reagent delivery device 10′ substantially corresponds to device 10 used in Example 1 except that carriers 16,26 are attached, as shown in FIG. 4, not only to face 14, but also to face 18, of support 12. Reagent delivery device 30 substantially corresponds to reagent delivery device 30 used in Example 2 (S&S 8S paper used for carriers 36). A cyanide standard having a concentration of approximately 100 ppm and a pH of approximately 11, is prepared. The preferred photometric method of Example 3 is repeated.

Visual evaluation of the color of test pads 36 as in Example 3, reveals an intensified very dark color for which the color chart calibrated for S&S 404 paper is not useful. However, by the use of color development chemistry that is less sensitive, for instance, by choosing a less sensitive pyridine compound such as nicotinic acid, and by color matching an appropriately calibrated color chart, one skilled in the art would expect that an accurate cyanide value of 100 ppm may be obtained by comparison to the color chart.

As before, after allowing color development of the liquid in microcuvette 50 for 3 minutes from withdrawal of reagent delivery device 30 from microcuvette 50, the color of the liquid in the microcuvette is photometrically evaluated. The OD reading is found to exceed the 2.00 OD upper limit of the photometer. As one skilled in the art will appreciate, use of a photometer having an appropriately higher OD upper limit and of a microcuvette having a shorter light path, could be used to quantitatively determine the OD value of the liquid. A final pH of 6.6 is measured.

Repeat of this Example using reagent delivery device 10 in place of reagent delivery device 10′, yields like results for the color of pads 36 and for the liquid OD (less than one minute allowed for color development of the liquid after withdrawal of reagent delivery device 30 from microcuvette 50, before photometric analysis). A final pH of 6.8 is measured.

Repeat of this Example using a cyanide standard having a concentration of approximately 200 ppm and a pH of approximately 11, likewise reveals an intensified very dark color upon visual examination of pads 36, and an OD reading of the liquid in the microcuvette after the 3 minute interval, that exceeds the 2.00 OD upper limit of the photometer. Here again by the use of color development chemistry that is less sensitive and by color matching an appropriately calibrated color chart, one skilled in the art would expect that an accurate cyanide value of 200 ppm may be obtained by comparison to the color chart, and that use of a photometer having an appropriately higher OD upper limit limit and of a microcuvette having a shorter light path, could be used to quantitatively determine the OD value of the liquid. A final pH of 6.8 is measured.

### EXAMPLE 6

This Example shows the effect on optical density from varying the molarity and molar ratio of Konig reagents. To eliminate determining the amounts of the Konig reagents actually delivered from an inventive reagent delivery device, the Konig reagents are delivered in liquid solution form.

1,3-DMB solution is prepared by dissolving 19.6 wt. % 1,3-DMB in distilled water containing 4 wt. % sodium hydroxide. An INA solution is prepared by dissolving 22.4 wt. % INA in distilled water containing 6.9 wt. % sodium hydroxide. Small volumes of these solutions are then added to a plurality of microcuvettes to prepare a plurality of INA and 1,3-DMB reagent solution mixtures that differ from one another in the amounts of INA and 1,3-DMB and hence in the INA to 1,3-DMB ratio. For a 2 ml sample as described in the next paragraph, the graphs of FIGS. 7 and 8 show the molarity of 1,3-DMB (“Barbituric Acid Compound”) and the molarity of INA (“Pyridine Compound”) for the various INA and 1,3-DMB reagent solution mixtures prepared and evaluated. Molarity is calculated based on the molecular weight of 1,3-DMB and the molecular weight of INA; in other words, the contribution of sodium to molecular weight is not taken into account.

A cyanide standard having a concentration of approximately 0.3 ppm cyanide and a pH of approximately 11, is prepared. To 20 ml of the cyanide standard, 400 μl of a pH 4 buffer solution prepared from 22.5 wt. % sodium phosphate monobasic dihydrate and deionized water, and 10 drops of a 0.5 wt. % sodium hypochlorite solution (deionized water) are added. After brief mixing to promote cyanide to cyanogen chloride conversion, 2 ml portions of the resulting solution are each added to a microcuvette containing one of the 1,3-DMB and INA reagent solution mixtures, a timer is started, and each microcuvette is inverted three times to promote color development.

A CO7500 Colorimeter is zeroed using a water sample free of cyanide in an additional microcuvette. For the spectrophotometric analyses, after 5 and 10 minutes as determined by the timer, each of the microcuvettes is inserted in the cell chamber of the colorimeter. The OD results are shown in the graphs of FIGS. 7 and 8.

FIGS. 7 and 8 show that as the level of Barbituric Acid Compound increases, an increase in the OD is observed. The 10 minute OD graph further shows that for each level of Barbituric Acid Compound, increase in the level of Pyridine Compound increases the OD until the level of Pyridine Compound is approximately 0.04 M: for 0.003 M Barbituric Acid Compound, this level of Pyridine Compound approximately corresponds to a 13:1 ratio (molar basis) of Pyridine Compound to Barbituric Acid Compound (initially, the molar ratio of Pyridine Compound to Barbituric Acid Compound is approximately 1:1); for 0.006 M Barbituric Acid Compound, this level of Pyridine Compound approximately corresponds to a 6.5:1 ratio (molar basis) of Pyridine Compound to Barbituric Acid Compound (initially, the molar ratio of Pyridine Compound to Barbituric Acid Compound is approximately 1:2); for 0.016 M Barbituric Acid Compound, this level of Pyridine Compound approximately corresponds to a 2.5:1 ratio (molar basis) of Pyridine Compound to Barbituric Acid Compound (initially, the molar ratio of Pyridine Compound to Barbituric Acid Compound is approximately 1:4); and for 0.032 M Barbituric Acid Compound, this level of Pyridine Compound approximately corresponds to a 1:1 ratio (molar basis) of Pyridine Compound to Barbituric Acid Compound (initially, the molar ratio of Pyridine Compound to Barbituric Acid Compound is approximately 1:8).

Final pH after 20 minutes for the analytical samples containing 0.001 g 1,3-DMB (0.003 M Barbituric Acid Compound), is found to be approximately 6. Final pH after 20 minutes for the analytical samples containing 0.002 g 1,3-DMB (0.006 M Barbituric Acid Compound), is found to range from 5.8 to 6.4. Final pH after 20 minutes for the analytical samples containing 0.005 g 1,3-DMB (0.016 M Barbituric Acid Compound), is found to range from 5.9 to 6.3. Final pH after 20 minutes for the analytical samples containing 0.010 g 1,3-DMB (0.032 M Barbituric Acid Compound), is found to range from 5.5 to 6.2. For the 0.002, 0.005 and 0.010 g 1,3-DMB analytical samples, the final pH is observed to increase as the ratio of INA to 1,3-DMB is increased.

### EXAMPLE 7

Like Example 6, to eliminate determining the amounts of the Konig reagents actually delivered from an inventive reagent delivery device, the Konig reagents are delivered in liquid solution form.

A 1,3-DMB solution is prepared by dissolving 19.6 wt. % 1,3-DMB in distilled water containing 4 wt. % sodium hydroxide. An INA solution is prepared by dissolving 22.4 wt. % INA in distilled water containing 6.9 wt. % sodium hydroxide. Small volumes of these solutions are then added to four microcuvettes to prepare four 1,3-DMB and INA reagent solution mixtures that include 0.002 g INA but differ from one another in the amounts of 1,3-DMB and hence in the INA to 1,3-DMB ratio. For a 2 ml sample as described in the next paragraph, the graph of FIG. 9 shows the molarity of 1,3-DMB (“Barbituric Acid Compound”) for the various 1,3-DMB and INA (“Pyridine Compound”; 0.008 M) reagent solution mixtures prepared and evaluated. As in Example 6, molarity is calculated based on the molecular weight of 1,3-DMB and the molecular weight of INA; in other words, the contribution of sodium to molecular weight is not taken into account.

To 10 ml of the cyanide standard used in Example 6, 200 μl of a pH 4 buffer solution prepared from 22.5 wt. % sodium phosphate monobasic dihydrate and deionized water, and 5 drops of a 0.5 wt. % sodium hypochlorite solution (deionized water) are added. After brief mixing to promote cyanide to cyanogen chloride conversion, 2 ml portions of the resulting solution are each added to a microcuvette containing one of the 1,3-DMB and INA reagent solution mixtures, a timer is started, and each microcuvette is inverted three times to promote color development.

A CO7500 Colorimeter is zeroed as in Example 6, and after 10 and 20 minutes as determined by the timer, each of the microcuvettes is inserted in the cell chamber of the colorimeter. The OD results are shown in the graph of FIG. 9.

At the 10 and 20 minute intervals, as the level of Barbituric Acid Compound is increased relative to the level of Pyridine Compound, the graph shows substantially no change in OD as the molar ratio of Pyridine Compound to Barbituric Acid Compound decreases from approximately 1:4 to approximately 1:10, but that as the ratio further decreases to approximately 1:30, a significant decrease in OD is observed.

### EXAMPLE 8

This Example shows the effect on completeness of color development from varying the molarity of Konig reagents. To eliminate determining the amounts of the Konig reagents actually delivered from an inventive reagent delivery device, the Konig reagents are delivered in liquid solution form. Thus, a solution of 14.4 wt. % INA and 12.8 wt. % 1,3-DMB is prepared substantially as described in Example 1.

A cyanide standard having a concentration of approximately 0.7 ppm cyanide and a pH of approximately 11, is prepared. To 20 ml of the cyanide standard, 3 ml of a pH 4 buffer solution prepared from 22.5 wt. % sodium phosphate monobasic dihydrate and deionized water, and 10 drops of a 0.5 wt. % sodium hypochlorite solution (deionized water) are added. After brief mixing to promote cyanide to cyanogen chloride conversion, 2 ml portions of the resulting solution are each added to three microcuvettes, to each of which a selected small volume of the INA and 1,3-DMB solution is added, a timer is started, and each microcuvette is inverted three times to promote color development.

The resulting three mixtures in the microcuvettes differ from one another in molarity of INA and 1,3-DMB. The graph of FIG. 10 shows the molarity of 1,3-DMB (“Barbituric Acid Compound”) and the molarity of INA (“Pyridine Compound”) for the three mixtures. The molar ratio of Pyridine Compound to Barbituric Acid Compound is constant, and is 1.4:1. Molarity is calculated based on a 2 ml volume, and the molecular weight of 1,3-DMB and the molecular weight of INA. The contribution of sodium to molecular weight is not taken into account.

A CO7500 Colorimeter is zeroed as in Example 6, and after 1, 2, 3, 4 and 5 minutes as determined by the timer, each of the microcuvettes is inserted in the cell chamber of the colorimeter. The OD results are shown in the graph of FIG. 10.

FIG. 10 shows that color development is 98% or 99% complete at the 2 minute interval when the molarity of the Barbituric Acid Compound is 0.06 M (0.019 g 1,3-DMB) or more, and the molarity of the Pyridine Compound is 0.086 M (0.021 g INA) or more. FIG. 10 additionally shows that color development is 93% complete at the one minute interval when the molarity of the Barbituric Acid Compound is 0.072 M (0.023 g 1,3-DMB) and the molarity of the Pyridine Compound is 0.102 M (0.025 g INA).

### EXAMPLE 9

In this Example, reagent delivery devices 10,30 substantially correspond to those used in Example 2 (S&S 8S paper for pads 36 of device 30). The procedure of Example 2 is substantially followed using 2 ml of a different cyanide standard having a concentration of approximately 0.7 ppm cyanide (pH approximately 11). The pH of pads 36 is 6.6.

Visual examination of the color of test pads 36 as in the Example 2, reveals a further intensified color and results in a determination of an elevated cyanide value greater than 2 ppm.

After allowing color development of the liquid in the microcuvette for 1, 2, 3, 4 and 5 minutes from withdrawal of reagent delivery device 30 from the liquid in the microcuvette, the color of the liquid in the microcuvette is photometrically evaluated, and the OD readings at the 1, 2, 3, 4 and 5 minute intervals are as follows (the CO7500 Colorimeter is first zeroed as in Example 1): 0.85, 0.95, 0.96, 0.97 and 0.97. These OD readings show that color development is substantially complete within 2 minutes and accordingly increased speed of color development using 8S paper and an estimated delivery of the color-forming reagents of 0.07 M INA and 0.05 M 1,3-DMB (molar ratio of 1.4:1; as before, contribution of sodium to molecular weight is not taken into account). A final pH of 6.7 is measured after 10 minutes.

### EXAMPLE 10

In this Example, reagent delivery devices 10,30 substantially correspond to those used in Example 1, and in addition, reagent delivery devices 10,30 are prepared by impregnation of S&S 8S paper and OL 50 paper. The method of Example 1 is substantially followed using 2 ml of a different cyanide standard having a concentration of approximately 0.7 ppm cyanide (pH approximately 11).

As in Example 1, after allowing color development of the liquid in the microcuvette for 3, 5 and 10 minutes from withdrawal of reagent device 30, the color of the liquid in the microcuvette is photometrically evaluated, and the respective OD readings at 3, 5 and 10 minutes are as follows:
404 paper: 0.52, 0.73, 0.82
8S paper: 0.89, 0.89, 0.89
OL 50 paper: 0.86, 0.87, 0.87.

The present invention may be carried out with various modifications without departing from the spirit or essential attributes thereof. Accordingly, reference should be made to the appended claims, rather than to the foregoing specification as indicating the scope of the invention.

1. A colorimetric method for cyanide analysis comprising
reacting cyanide in an appropriately buffered aqueous sample, with an effective amount of a suitable water soluble halogenating reagent for converting the cyanide to a cyanogen halide, wherein said water soluble halogenating reagent is selected from the group consisting of a chlorinating reagent and a brominating reagent;
delivering from a fibrous matrix disposed on a support into the resulting cyanogen halide-containing liquid by wetting-contact of said fibrous matrix therewith, an effective amount of a suitable water soluble cyanogen halide-reactive pyridine compound for providing a Konig Reaction intermediate, and an effective amount of a suitable water soluble barbituric acid compound for reacting with said Konig Reaction intermediate to yield a colorimetrically analyzable, colored complex, wherein an appropriately buffered reaction environment is provided for this step;
within an appropriate period of time after beginning said wetting-contact, withdrawing said fibrous matrix from the liquid and analyzing the fibrous matrix color for the level of cyanide in said aqueous sample; and
within about ten minutes after said withdrawing of said fibrous matrix from the liquid, photometrically analyzing the liquid for the level of cyanide in said aqueous sample.

2. The method of claim 1, wherein said halogenating reagent is delivered with an effective amount of a suitable water soluble buffer, into said aqueous sample from a common support.

3. The method of claim 2, wherein said halogenating reagent is chloramine-T hydrate.

4. The method of claim 1, wherein said water soluble pyridine compound is selected from the group consisting of isonicotinic acid, nicotinic acid, and isonicotinamide, in a water soluble salt form, a pyridinium salt, and pyridine-3-nitrophthalic acid.

5. The method of claim 1, wherein said water soluble barbituric acid compound is selected from the group consisting of barbituric acid and 1,3-dimethylbarbituric acid, in a water soluble salt form.

6. The method of claim 1, wherein the colorimetric analysis of said fibrous matrix is within about one minute from beginning said wetting-contact.

7. The method of claim 1, wherein said fibrous matrix has a water absorbency value (g/100 cm²) greater than 1.7, and said liquid color is photometrically analyzed within about 5 minutes after said withdrawing of said fibrous matrix from the liquid.

8. The method of claim 1, wherein said fibrous matrix has a water absorbency value (g/100 cm²) greater than 1.7, and said liquid color is photometrically analyzed within about 3 minutes after said withdrawing of said fibrous matrix from the liquid.

9. The method of claim 1, wherein said aqueous sample has a volume of about 2 ml.

10. The method of claim 1, wherein said aqueous sample is at a temperature in the range of about 15 to 28° C.

11. A photometric method for cyanide analysis comprising
disposing a photometric cell containing an aqueous sample in a photometric instrument;
delivering from a first support into the aqueous sample wherein said photometric cell is disposed in said photometric instrument, an effective amount of a suitable water soluble halogenating reagent for reacting with the cyanide in said aqueous sample to yield a cyanogen halide, and providing a mixing action, wherein said water soluble halogenating reagent is selected from the group consisting of a chlorinating reagent and a brominating reagent, and an appropriately buffered reaction environment is provided;
withdrawing said first support from the cyanogen halide-containing liquid;
thereafter delivering from a fibrous matrix disposed on a second support into the cyanogen halide-containing liquid by wetting-contact of said fibrous matrix therewith, an effective amount of a suitable water soluble cyanogen halide-reactive pyridine compound for providing a Konig Reaction intermediate, and an effective amount of a suitable water soluble barbituric acid compound for reacting with said Konig Reaction intermediate to yield a colorimetrically analyzable, colored complex, and providing a mixing action, by moving said second support in the liquid, wherein an appropriately buffered reaction environment is provided for this step;
within an appropriate period of time after beginning said wetting-contact, withdrawing said second support from the liquid; and
within an appropriate period of time after said withdrawing of said second support, photometrically analyzing the liquid for the level of cyanide in said aqueous sample, wherein said photometric cell remains in said photometric instrument until after the photometric analysis.

12. The method of claim 11, further comprising prior to the halogenating reagent delivery step, obtaining a blank reading for said aqueous sample and said photometric cell.

13. The method of claim 11, wherein said photometric analysis is within about ten minutes after said withdrawing of said second support from the liquid.

14. The method of claim 11, wherein said fibrous matrix has a water absorbency value (g100 cm²) greater than 1.7, and said photometric analysis is within about five minutes after said withdrawing of said second support from the liquid.

15. The method of claim 11, wherein said fibrous matrix has a water absorbency value (g/100 cm²) greater than 1.7, and said photometric analysis is within about three minutes after said withdrawing of said second support from the liquid.

16. The method of claim 11, wherein said fibrous matrix is colorimetrically analyzed.

17. A reagent delivery device for cyanogen halide analysis of an aqueous sample, said device comprising a support, and fixed to said support a fibrous matrix carrying an effective amount of a suitable water soluble cyanogen halide-reactive pyridine compound for providing a Konig Reaction intermediate, and an effective amount of a suitable water soluble barbituric acid compound for reacting with said Konig Reaction intermediate to yield a colorimetrically analyzable, colored complex, wherein said fibrous matrix has a water absorbency value (g/100 cm²) greater than 1.7 and a thickness greater than 0.25 mm.

18. The reagent delivery device of claim 17, wherein said fibrous matrix has a water absorbency value (g/100 cm²) in the range of about 1.8 to 3, and a thickness in the range of about 0.3 to 0.55 mm.

19. The reagent delivery device of claim 17, in combination with a microcuvette suitable for photometric analysis.
